(19) United States
(12) Patent Application Publication
(10) Pub. No.: US 2008/0274006 A1
(43) Pub. Date: Nov. 6, 2008

(54) Overlay cladding for molten metal processing

(76) Inventors: Mark Bright, Sewickley, PA (US); Vinod K. Sikka, Oak Ridge, TN (US); James W. Hales, Harrison, TN (US); Ravi Menon, Goodlettsville, TN (US); Ever J. Barbero, Morgantown, WV (US); Xingbo Liu, Morgantown, WV (US); Jing Xu, Morgantown, WV (US)

Correspondence Address: FAY SHARPE LLP, 1100 SUPERIOR AVENUE, SEVENTH FLOOR, CLEVELAND, OH, 44114, US

(21) Appl. No.: 11/799,394

(22) Filed: May 1, 2007

(51) Int. Cl. C22C 38/00; B23K 20/08; C22C 37/06; C22C 38/30; C22C 38/18; C22C 37/08

(52) U.S. Cl. 420/17; 228/107; 228/177; 420/15; 420/34; 420/36; 420/37; 420/38; 420/9

(57) ABSTRACT

A submerged pot roll and other articles for use in galvanizing baths including a metallurgically bonded superalloy cladding layer on a steel core layer. The cladding layer improves the corrosion resistance and dross buildup of the article and improves service life while reducing costs.

### STATEMENT OF GOVERNMENT INTEREST

The United States government has a paid up license in the invention and the right to license the invention under certain conditions as provided for in the terms of government grant number 01ID14042, funded by the U.S. Department of Energy.

### FIELD OF THE INVENTION

The present exemplary embodiments relate to coated industrial parts for use in molten metal baths. They find particular use as coated rolls used in galvanizing steel baths, but other applications are also contemplated.

### BACKGROUND

Galvanized steel utilized in the automotive, construction and appliance industries is formed in very thin strips, which are passed through a molten bath of either zinc (galvanizing), aluminum (aluminizing), or aluminum/zinc (galvanneal, galfan, galvalume, etc.), in which the levels of aluminum vary from a fraction of a percent to as much as 100 percent.

In a typical process, a heated metal or refractory/ceramic pot contains a bath of molten zinc/aluminum. A continuous moving strip of steel is introduced into the bath from a furnace in the conventional manner. The strip passes around a sink roll and stabilizer rolls while submerged in the bath, so the surface of the strip develops a zinc/aluminum coating. The strip is delivered to the bath through a conventional tubular snout. The interior of the snout housing typically contains an inert gas such as nitrogen or a mix of nitrogen and hydrogen. This procedure, as is well known to those skilled in the art, is useful in preventing the steel strip from oxidizing.

Because of the extremely large dimensions of the equipment and in spite of efforts to prevent all possible air leaks into the furnace, small leaks do occur, generating ferrous oxides (Fe₂O₃, FeO, etc.). When the steel strip enters the bath, a chemical process occurs in which the melt in the bath reacts with the iron in the steel strip (inducing the coating) but also reacts with the oxides to form dross that contains Fe—Zn, Fe—Zn—Al intermetallic compounds and/or aluminum oxides, etc. The free iron may react with zinc to form dross and settle to the bottom of the molten metal pot. Because of the nearly identical density to the molten metal, the oxides (Al₂O₃, ZnO) and the formed intermetallics remain in suspension or float to the surface as a dross. The dross increases in concentration by being confined in the zone comprised by the snout, the strip, the sink roll and the stabilizer rolls. As the dross level increases, deposits gradually form on top of the sink roll and the strip being processed.

Molten metal readily attacks and dissolves metallic components submerged therein. In turn, corrosion and wear result in contamination of the melt and loss of product quality. For industrial molten metal environments, it is important to keep hardware running as long as possible. Conventional steel submerged hardware used in steel galvanizing processes undergo dross buildup and liquid metal corrosion and require replacement typically within a couple of weeks. Thus, many times exotic and expensive alloys are used to maximize the life of these product components. Although such alloys can be effective in reducing degradation of the submerged metal parts, parts made from these alloys can be very costly and may lack the mechanical properties required to construct durable monolithic components from the alloys.

Thus, a need exists for resilient metal parts such as rolls used in galvanizing applications discussed above that can be made more inexpensively than monolithic parts utilizing so called “super alloys” developed for use in such applications.

### BRIEF DESCRIPTION

In a first aspect, there is provided an article intended to be submerged in molten zinc, aluminum or aluminum/zinc melts, the article comprised of a steel alloy core material and a metallurgically bonded surface cladding comprising an alloy including carbon, chromium, nickel, tungsten, molybdenum, vanadium, niobium (columbium), cobalt, boron, iron, and zirconium.

In a second aspect, there is provided an article intended to be submerged in molten zinc, aluminum or aluminum/zinc melts, the article comprised of a steel alloy core material and a metallurgically bonded surface cladding having the following composition, in weight percentages: 0.5<C<3.0; 15.0<Cr<30.0; 0.0≦Ni<30.0; 5.0<W<20.0; 5.0<Mo<30.0; 0.0≦V<6.0; 0.0≦Co<20.0; 10.0<Fe<50.0; 0.0≦Zr≦6.0.

In a third aspect, there is provided an article intended to be submerged in molten zinc, aluminum or aluminum/zinc melts, the article comprised of a steel alloy core material and a metallurgically bonded surface cladding having the following composition, in weight percentages: 0.0≦V<6.0; 0.0≦Co<20.0; 0.0≦B<5.0; 0.0≦Ni<30.0; and. 10.0<Fe<50.0.

In a fourth aspect, there is provided an article intended to be submerged in molten zinc, aluminum or aluminum/zinc melts, the article comprised of a steel alloy core material and a metallurgically bonded surface cladding having the following composition, in weight percentages: 1.6<C<2.6; 15.0<Cr<30.0; 0.0<Ni<30.0; 10.0<W<30.0; 1.0<Mo<10.0; 0.0<V<6.0; 0.0<Nb<6.0; 0.0<Co<20.0; 0.0≦B<5.0; 10.0<Fe<50.0; 0.0≦Zr<6.0; 2<Mn<6.5; 0.0≦Si≦3.5; and including at least about 12% by weight of the combination of vanadium, tungsten and molybdenum; being substantially free of silicon; including greater than 8% by weight of the combined elements vanadium, molybdenum and niobium; including less than 32% by weight of the combined elements nickel and cobalt; and including greater than 27% by weight and less than 65% by weight of the combined elements chromium, tungsten, molybdenum, vanadium, and niobium.

In a fifth aspect, there is provided an article intended to be submerged in molten zinc, aluminum or aluminum/zinc melts, said article comprised of a steel alloy core material and a metallurgically bonded surface cladding having the following composition, in weight percentages: 1.0<C<5.0; 10.0<Cr<30.0; 0.0≦Ni<30.0; 1.0<W<15.0; 1.0<Mo<10.0; 0.0<V<10.0; 0.0<Nb<10.0; 0.0<Co<20.0; 0.0<B<5.0; 10.0<Fe<50.0; 0.0≦Zr≦6.0; 2<Mn<6.5; 0.0≦Si≦1.0.

### BRIEF DESCRIPTION OF THE DRAWINGS

FIG. 1 is a roll assembly for a galvanizing process according to one embodiment of the invention.

FIG. 2 is a graph showing the weight change (due to corrosion) versus time of alloys suitable for use in the present embodiments and conventional alloys.

FIGS. 3A and 3B show a closeup micrograph of the surface of a pot roll after 33 days static immersion in a galvanizing bath

### DETAILED DESCRIPTION OF THE PREFERRED EMBODIMENTS

Conventionally, the parts and other equipment (e.g. sink roll, coating roll, roll frame and snout) used in the hot dip metalizing process, when the alloy melt is zinc, aluminum, or zinc/aluminum, have been manufactured by centrifugal casting, sand mold casting or forging of stainless steel such as SUS309S (SAE30309S), SUS316 (SAE30316) and SUS316L (SAE30316L). The rolls and bearings, in particular, require continuous maintenance of their surfaces. The rolls are routinely withdrawn from the pot and their surfaces machined to remove accumulated dross, to smooth the roll surfaces as well as to return them to a round and straight condition. The main reason for this continuous maintenance is because 316L stainless steel and other conventional steels are not materials formulated specifically for this application and, consequently, lack the properties to meet the operational needs.

In order of importance, although all requirements must be met to a minimum degree, the properties required for a proper roll material that meets the operational needs are as follows:

Corrosion resistance to molten metal. The minimal acceptable rate of attack will depend on the exact composition of the molten alloy and the working conditions such as bath temperature.

Low adhesion (non-wettable) to zinc/iron and zinc/iron/aluminum dross. Wetting plays the main role in the bonding of solid-liquid state metals.

Very low solubility in molten zinc, aluminum or zinc/aluminum alloys.

High surface hardness to resist abrasive wear, which can contribute to nearly half of the loss of roll life in metalizing applications. Preferably a surface hardness of greater than R_{c} 20, more preferably greater than 40.

Dimensional stability at typical bath temperatures, for straightness and roundness. This property is necessary because of the difficulties encountered when the lines operate at over 400 feet per minute, generating excessive vibration and damage to the holding equipment.

Thermal shock resistance. The roll should be capable of withstanding a thermal shock of no less than 500° F. when going from air to the molten metal, and 1500° F. when going from the molten metal to air.

Good impact and notch resistance strength. This is important due to the severity of the application.

In addition, when discussing a roll having an outer cladding, the outer cladding material should preferably possess a coefficient of thermal expansion appropriately matched to the substrate metal, preferably within a range of about ±1.5×10⁻⁶ in/in° F. Finally, the roll should be easy and relatively inexpensive to refurbish. Such is a major advantage of the present overlay, as compared to thermal spraying.

Alloys have been made for use in these environments. Such materials can be found in U.S. Pat. Nos. 6,004,507; 6,168,757; 6,562,293; and 6,899,772, the disclosures of which are incorporated herein by reference in their entirety. Rolls made from such alloys show good resistance and other properties in such applications. Nevertheless, such rolls can be quite expensive to produce.

The present embodiments are directed to a roll having a conventional steel (or other material) core with a cladding of a super alloy according to one of the formulations in the above patents. This both reduces cost and optimizes strength of the rolls. A metallurgical bond is created between the cladding and the base metal substrate by using a high intensity process such as submerged arc welding, laser processing or other cladding process. This metallurgical bond provides an inherently stronger surface and more intimate bond with the base metal than a multicasting process, which is less prone to wear, coating breakdown, spalling, premature failure, etc., as compared to multiple casting steps or other processes, such as detailed in U.S. Pat. No. 5,713,408.

One advantage of the present cladding is that it is easy to remachine and refurbish the roll during maintenance, which reduces the total cost of maintenance due to the fact that the entire roll does not need to be replaced.

By metallurgical bond, it is meant that the core and cladding metals are joined by a process that produces a transitional change in the lattice structures of the materials, as they are merged and are forced into conformance with each other. These processes cause a sharing of electrons at the interface, which produces a bond on the atomic level. No intermediate layers such as adhesives or braze metal are involved.

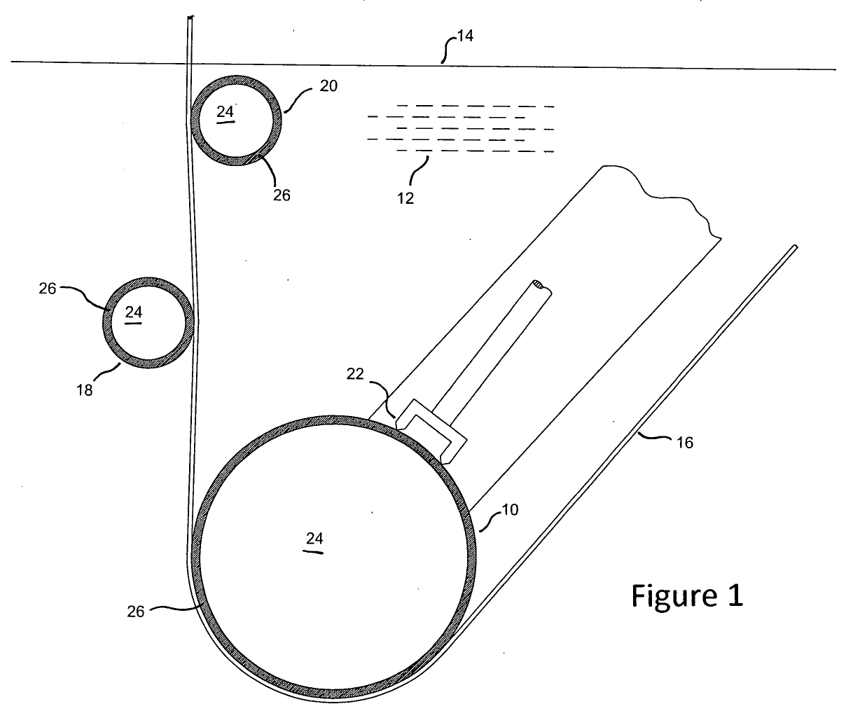

The present embodiments are primarily intended for rolls or other hardware in galvanizing baths. Thus, with reference to FIG. 1, a typical sink roll 10 is illustrated in a galvanizing bath 12 below the molten metal line 14. A metal strip 16 is trained around roll 10 and stabilizer rolls 18 and 20. A mechanical scraper 22 may be present to remove dross build-up on the roll.

As can be seen, the sink roll 10 and, optionally, the stabilizer rolls 18, 20 comprise a hollow cylinder including a core layer 24 of conventional steel (such as 316-L stainless steel) and a metallurgically bonded outer cladding layer 26 of a superalloy in accordance with the requirements above.

Preferred superalloys for use in the present embodiments include those described in one or more of these patents and designated as the AT-101 alloy therein.

Other preferred alloys include those having the following compositions:

| ELEMENT | WEIGHT PERCENT |
|---|---|
| Molybdenum | 3.00-7.00 |
| Tungsten | 3.00-13.00 |
| Cobalt | 4.00-16.00 |
| Chromium | 18.00-30.00 |
| Carbon | 0.50-2.50 |
| Vanadium | 1.70-4.30 |
| Nickel | 0.01-22.00 |
| Manganese | 0.40-6.50 |
| Silicon | 0.05-1.20 |
| Iron | Balance |

The above alloys may also contain Niobium up to an amount of about 3.5% and boron up to an amount of about 0.60%. Preferably, the above alloys also contain 0.05% or less of phosphorus, sulfur, titanium, aluminum, and copper, and more preferably 0.00% of these elements.

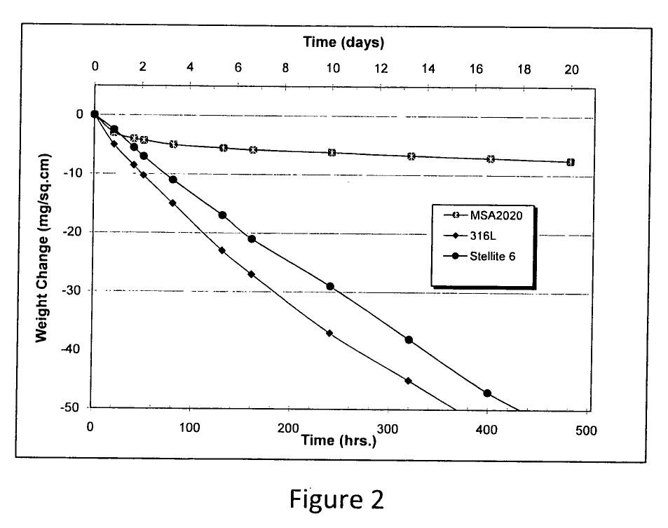

FIG. 2 shows the weight loss (due to corrosion and dross buildup) of rolls made from the superalloy MSA2020 (composition defined below) in a static state molten zinc bath (0.16% Al) at 465° C. as compared to conventional stainless steel 316L and the cobalt alloy Stellite® 6 (available from Deloro Stellite). The present alloys show minimal weight loss compared to the others.

The composition of the MSA2020 alloy comprises:

| ELEMENT | WEIGHT PERCENT |
|---|---|
| Molybdenum | 4.00 |
| Tungsten | 10.50 |
| Cobalt | 15.00 |
| Chromium | 19.00 |
| Carbon | 2.20 |
| Boron | 0.10 |
| Vanadium | 2.75 |
| Nickel | 0.10 |
| Niobium | 0.03 |
| Manganese | 0.75 |
| Silicon | 0.20 |
| Iron | Balance |

The present embodiments contemplate cladding of other structures inside the galvanizing bath such as bearings, bushings etc. In fact, the cladding of other such structures will improve the overall performance of the galvanizing process in such instances. In addition, the cladding could also be applied to an inside surface of batch galvanizing kettles. Thus, a galvanizing kettle has an inside surface that is exposed to a molten galvanizing bath. Coated on the inside surface is a cladding of the superalloy.

The thickness of the cladding layer 26 can vary depending on the formulation of the superalloy as well as the environment in which the cladded part is used. Nevertheless, a relatively thicker cladding layer (e.g. greater than about 0.06 inches) is preferred over a typically thin coating (for example about 100 μm as could be applied using a plasma spray coating method) to improve scratch and marking resistance by solid particles in the bath as well as allowing the re-machining and reworking of the cladding layer several times before reapplication was necessary. An exemplary cladding layer is from about 0.03 to 0.50 inches, in one embodiment from about 0.04 to 0.20 inches thick, and in another embodiment from about 0.05 to 0.15 inches thick.

The cladding of the core steel material with the superalloy can be accomplished in several ways including roll bonding, explosive bonding, weld overlaying and “wallpapering”. Weld overlaying is commonly used to clad the surfaces of fabricated steel structures. The actual weld overlay process used depends on many factors including access, welding position, the alloy applied, and economics.

Submerged Arc Welding (SAW) is a common arc weld overlaying process. It generally requires a continuously fed consumable solid or tubular (metal cored) electrode. The molten weld and the arc zone are protected from atmospheric contamination by being “submerged” under a blanket of granular fusible flux. When molten, the flux becomes conductive, and provides a current path between the electrode and the work. Any conventional SAW process would be applicable for the present embodiments. SAW is normally operated in the automatic or mechanized mode, however, semi-automatic (hand-held) SAW guns with pressurized or gravity flux feed delivery are available. In some alloy combinations or applications, dilution of the weld overlay material by the underlying steel core material may require more than one weld pass.

Wallpapering, also known as sheet lining, was originally developed in the 1920's to fabricate stainless steel clad steel vessels for the chemical process industry. In wallpapering, thin sheets of corrosion resistant superalloy are edge welded to the underlying steel structure.

In roll bonding, strips of the two metals to be joined pass through a highly customized rolling mill designed specifically for cladding. As they pass through the mill, the rolls exert immense pressure that reduces strip thickness and creates a metallurgical bond as the atomic lattices of the different metals merge into a common structure. The resulting composite material—a clad metal—derives its integrity from this shared electron interface. Heat is then applied to induce diffusion, which improves bond strength and provides stress relief for cold processing. The result: a clad metal imbued with precisely the right properties for its specific application.

Another suitable method for applying the cladding is explosive welding wherein a layer of substrate metal is impelled by means of an overlying explosive charge against the cladding metal to bond the surfaces of the metals together. This explosive bonding method gives excellent bond strength and is applicable to almost all combinations of substrate and cladding metals without being unduly restricted by compatibility requirements.

It is preferred to apply the superalloy weld overlays by submerged arc welding using a flux which is compatible with it. Suitable fluxes include those sold by Hobart, Lincoln and others. The principal issue with a flux is attaining ease of slag removal and good weld bead appearance. Suitable, but non-limiting conditions for the welding: Electrode size: 30 mm×0.75 mm (1⅕×0.03 inch); Current: 500-1000 amps DCRP, preferably about 750 amps; Voltage: 21-30 volts, preferably 22-25 volts (variable voltage more preferred); Surface travel speed: 7.5-63.5 cm/min, (3 to 25 in/min), preferably 25. 5-38.0 cm/min; Bead height: 0.25-0.32 cm ( 3/32-⅛ inch); Bead width: 3.17-3.5 cm ( 11/4- 13/4 inch); Bead overlap: 0.64 cm (¼ inch).

### EXAMPLE

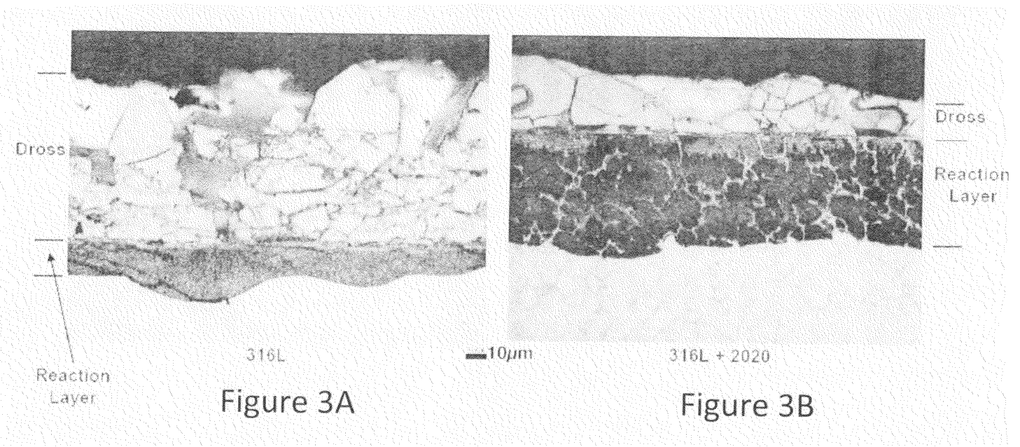

FIGS. 3A and 3B show a closeup micrograph of the surface of a sink (pot) roll after 33 days static immersion in a galvanizing bath. FIG. 3A is a monolithic roll made with 316L stainless steel. FIG. 3B shows the same roll having a weld-overlay cladding of MSA2020 superalloy. As can be seen, the excellent nonwetting surface of the MSA2020 clad roll significantly reduces the thickness of the dross layer compared to the unclad roll.

Thus, such claddings have shown a 4 to 5 times reduction in the dross buildup and a corresponding increase in serviceable life.

In addition, wettability studies were conducted comparing roll surfaces made from MSA2020 and 316L stainless steel using the sessile drop testing method, which is a known test method that measures the optical contact angle to determine the wetting behavior of solids. In the test, a molten drop of zinc-aluminum alloy, having 0.23% by weight Al, is placed on the surface of the test specimens at 465° C. for 2 hours under an argon atmosphere with 4% H₂. The MSA2020 sample showed no wetting (greater than 90° wetting angle), while the 316L sample showed complete wetting (0° contact angle). The same results are found when the testing is extended to 4 hours at 465° C. After 40 minutes at 600° C., there is still no wetting of the MSA2020 surface by the alloy.

It should be noted that these examples are exemplary in nature and in no way are meant to be exhaustive or restrictive of the scope of the invention, but are for illustration of the concept of this invention. One skilled in the art will recognize the applicability of the inventive concept to a large number of different embodiments.

The invention has been described with reference to the preferred embodiment. Obviously, modifications and alterations will occur to others upon reading and understanding the preceding, detailed description. It is intended that the invention be construed as including all such modifications and alterations, insofar as they come within the scope of the appended claims or the equivalents thereof.

What is claimed is:

1. An article intended to be submerged in molten zinc, aluminum or: aluminum/zinc melts, said article comprised of a steel alloy core material and a metallurgically bonded surface cladding comprising a cladding alloy comprised of carbon, chromium, nickel, tungsten, molybdenum, vanadium, niobium, cobalt, boron, manganese, and iron.

2. The article according to claim 1, wherein said cladding alloy has the following composition, in weight percentages:
0.5<C<3.0
15.0<Cr<30.0
0.0≦Ni<30.0
5.0<W<20.0
5.0<Mo<30.0
0.0≦V<6.0
0.0≦Co<20.0
10.0<Fe<50.0
0.0≦Zr≦6.0.

3. The article according to claim 1, wherein said cladding alloy has the following composition, in weight percentages: between about 0-6% vanadium, between about 0-20% cobalt, between about 0-5% boron, between about 0-30% nickel, and between about 10 and 50% iron.

4. The article of claim 1, wherein said cladding alloy further comprises chromium in a range of between about 15-30 wt %.

5. The article of claim 1, wherein said cladding alloy further comprises molybdenum in a range of between about 5-30 wt %.

6. The article of claim 1, wherein said cladding alloy further comprises tungsten in a range of between about 10-30 wt %.

7. The article of claim 1, wherein said cladding alloy further comprises carbon in a range of between about 0.5-30.0 wt %.

8. The article of claim 3, wherein said cladding alloy further comprises carbon in a range of between about 1.6-2.6 wt %, chromium in a range of between about 15-30 wt %, tungsten in a range of between about 10-30 wt %, molybdenum in a range of between about 2.0-8.0 wt %, and zirconium in a range of between about 0.0-0.6 wt %.

9. The article of claim 3, wherein said cladding alloy further comprises molybdenum in a range of about 2.0-8.0 wt %, niobium in a range of about 0-6 wt %, and zirconium in a range of between 0-6 wt %.

10. The article of claim 1, where said cladding has a thickness of at least about 0.03 inches.

11. The article of claim 10, wherein said cladding has a thickness of from about 0.03 to 0.5 inches.

12. The article of claim 1, wherein said cladding is metallurgically bonded to said core material by one of the processes selected from the group consisting of: roll bonding, explosive bonding, weld overlaying and wallpapering.

13. The article of claim 1, wherein said cladding has a surface hardness R_{c} of greater than 20.

14. The article of claim 1, wherein said article comprises a roll.

15. The article of claim 1, wherein said cladding alloy has the following composition, in weight percentages:
1.6<C<2.6
15.0<Cr<30.0
0.0<Ni<30.0
10.0<W<30.0
1.0<Mo<10.0
0.0<V<6.0
0.0<Nb<6.0
0.0<Co<20.0
0.0≦B<5.0
10.0<Fe<50.0
0.0≦Zr≦6.0
2<Mn<6.5
0.0≦Si≦3.5;
and including at least about 12% by weight of the combination of vanadium, tungsten and molybdenum; including greater than 8% by weight of the combined elements vanadium, molybdenum and niobium; including less than 32% by weight of the combined elements nickel and cobalt; and including greater than 27% by weight and less than 65% by weight of the combined elements chromium, tungsten, molybdenum, vanadium, and niobium.

16. The article of claim 15, wherein said cladding is metallurgically bonded to said core material by one of the processes selected from the group consisting of: roll bonding, explosive bonding, weld overlaying and wallpapering.

17. An article according to claim 1, wherein said cladding alloy has the following composition, in weight percentages:
1.0<C<5.0
10.0<Cr<30.0
0.0≦Ni<30.0
1.0<W<15.0
1.0<Mo<10.0
0.0<V<10.0
0.0<Nb<10.0
0.0<Co<20.0
0.0<B<5.0
10.0<Fe<50.0
0.0≦Zr≦6.0
2<Mn<6.5
0.0≦Si≦1.0.

18. The article of claim 1, wherein said surface cladding improves the corrosion resistance and dross attachment of the article.

19. A process for forming an article intended to be submerged in molten zinc, aluminum or aluminum/zinc melts, said process comprising the steps of:
a) providing a metal alloy core material;
b) forming said steel alloy core material into an article; and
c) metallurgically bonding a surface cladding to a surface of said article,
said cladding comprising an alloy comprised of carbon, chromium, nickel, tungsten, molybdenum, vanadium, niobium (columbium), cobalt, boron, iron, and zirconium; wherein said surface cladding improves the corrosion resistance and dross attachment of the article.

20. The process of claim 19, wherein said step c) is performed by a process selected from the group consisting of: roll bonding, explosive bonding, weld overlaying, laser welding and wallpapering.

21. An article intended to be submerged in molten zinc, aluminum or aluminum/zinc melts, said article comprised of a steel alloy core material and a metallurgically bonded surface cladding comprising a cladding alloy, wherein said cladding alloy has the following composition, in weight percentages:
0.50<C<2.50
18.00<Cr<30.00
0.01≦Ni≦22.00
3.00<W<13.0
3.00<Mo<7.00
1.70<V<4.30
4.00<Co<16.00
10.0<Fe<50.0
0.40<Mn<6.50
0.05≦Si≦1.20.

22. The article of claim 21, wherein said cladding alloy comprises less than 3.5% niobium and less than 0.60% boron.

23. The article of claim 21, wherein said cladding alloy contains less than 0.05% phosphorus, sulfur, titanium, aluminum, and copper.

24. The article of claim 21, wherein said cladding alloy has the following composition, in weight percentages:

| | |
|---|---|
| Molybdenum | 4.00 |
| Tungsten | 10.50 |
| Cobalt | 15.00 |
| Chromium | 19.00 |
| Carbon | 2.20 |
| Boron | 0.10 |
| Vanadium | 2.75 |
| Nickel | 0.10 |
| Niobium | 0.03 |
| Manganese | 0.75 |
| Silicon | 0.20 |
| Iron | Balance. |
